(19) United States
(12) Patent Application Publication
(10) Pub. No.: US 2014/0169819 A1
(43) Pub. Date: Jun. 19, 2014

(54) FIXING APPARATUS AND IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Hiroshi KATAKURA, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/098,362

(22) Filed: Dec. 5, 2013

(30) Foreign Application Priority Data
Dec. 17, 2012 (JP) 2012-274653

(51) Int. Cl. G03G 15/20

(52) U.S. Cl. CPC G03G 15/2014
USPC 399/69; 399/329; 399/333

(57) ABSTRACT

A fixing apparatus includes a first rotating unit and a second rotating unit. The first rotating unit has a heat generating unit and center and end portions that are configured to rotate around a first rotational axis. The second rotating unit has center and end portions that are configured to rotate around a second rotational axis. The second rotating unit is urged towards the first rotating unit and positioned to form a nip between the first rotating unit and the second rotating unit. At least one of the first rotating unit and the second rotating unit has a shape where a diameter of the center portion is greater than a diameter of the end portion.

### CROSS-REFERENCE TO RELATED APPLICATION

This application is based upon and claims the benefit of priority from Japanese Patent Application No. 2012-274653, filed Dec. 17, 2012, the entire contents of which are incorporated herein by reference.

### FIELD

Embodiments described herein relate to a fixing apparatus of an image forming apparatus, such as a printer or a multi-function peripheral, to fix an image onto a sheet.

### BACKGROUND

An image forming apparatus such as a printer or a multi-function peripheral (MFP) usually includes a fixing unit in which an image is fixed onto a sheet when the sheet is heated and pressed. In one type of the fixing unit, the sheet is pressed in a nip with a significant amount of pressing force so that the image can be fixed onto the sheet even when the sheet is heated at a lower temperature. The lower temperature may be used to same energy or to prevent the fixed image from being erased when the fixing unit operates in a higher temperature. However, when the pressing force is increased too much, a fixing component that is applied the pressing force may deform. As a result, the sheet may be pressed with a pressing force that is not uniform.

### BRIEF DESCRIPTION OF THE DRAWINGS

FIG. 1 is a schematic diagram of a MFP as an image forming apparatus according to a first embodiment.

FIG. 2 is a schematic diagram of a fixing apparatus according to the first embodiment.

FIG. 3 is a schematic diagram illustrating an outlet pressing roller according to the first embodiment.

FIG. 4 is a graph showing a distribution of a nip width in a longitudinal direction of the outlet pressing roller according to the first embodiment.

FIG. 5 is a graph showing a distribution of a surface pressure at the nip in a longitudinal direction of the outlet pressing roller according to the first embodiment.

FIG. 6 is a graph showing the variation of a minimum fixing temperature in the longitudinal direction of a heating roller according to the first embodiment.

FIG. 7 is a schematic diagram of a fixing apparatus according to a second embodiment.

FIG. 8 is a schematic diagram of an outlet pressing roller according to the second embodiment.

FIG. 9 is a graph showing a distribution of a nip width in a longitudinal direction of the outlet pressing roller according to the second embodiment.

FIG. 10 is a graph showing a distribution of a surface pressure at the nip in the longitudinal direction of the outlet pressing roller according to the second embodiment.

FIG. 11 is a graph showing the variation of a minimum fixing temperature in the longitudinal direction of a heating roller according to the second embodiment.

### DETAILED DESCRIPTION

In accordance with one embodiment, a fixing apparatus includes a first rotating unit and a second rotating unit. The first rotating unit has a heat generating unit and center and end portions that are configured to rotate around a first rotational axis. The second rotating unit has center and end portions that are configured to rotate around a second rotational axis. The second rotating unit is urged towards the first rotating unit and positioned to form a nip between the first rotating unit and the second rotating unit. At least one of the first rotating unit and the second rotating unit has a shape where a diameter of the center portion is greater than a diameter of the end portion. Embodiments are described below with reference to accompanying drawings.

### First Embodiment

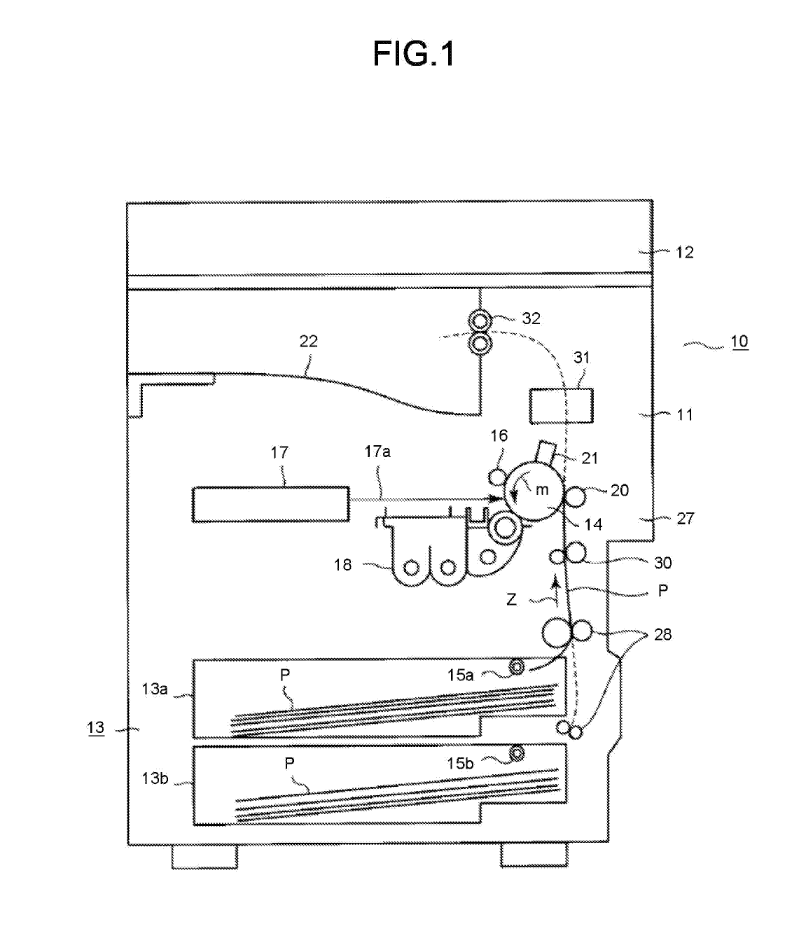

An image forming apparatus according to a first embodiment is described below with reference to FIG. 1-FIG. 6. FIG. 1 is a schematic diagram of a multi function peripheral (hereinafter referred to as MFP for short) 10 serving as an example of the image forming apparatus according to the first embodiment. The MFP 10 comprises a printer section 11 serving as an image forming section, a scanner section 12, a paper feed section 13 and a paper discharge section 22.

The paper feed section 13 comprises a first paper feed cassette 13a and a second paper feed cassette 13b which are separately provided with a paper feed roller 15a and a paper feed roller 15b, respectively. The paper feed cassettes 13a and 13b are capable of feeding an unused sheet or a sheet for reuse (sheet the image on which has been erased through an erasing processing) as a sheet P serving as a recording medium.

The printer section 11 comprises a charger 16 for uniformly charging a photoconductive drum 14 rotating in a direction indicated by an arrow m and a laser exposer 17 which forms an electrostatic latent image on the photoconductive drum 14 by irradiating the charged photoconductive drum 14 with laser light 17a based on the image data and the like from the scanner section 12. The printer section 11 comprises a developing device 18 for supplying toner to the electrostatic latent image on the photoconductive drum 14, a transfer device 20 for transferring a toner image formed on the photoconductive drum 14 to a sheet P serving as a recording medium and a cleaner 21.

The developing device 18 supplies the toner to the electrostatic latent image on the photoconductive drum 14 using a two-component developing agent, which is, for example, a mixture of the toner and a magnetic carrier. The toner used in the two-component developing agent is, for example, decolorizable toner which can be decolorized when heated at a given temperature. The decolorizable toner is prepared by adding a color material to a binder resin. The color material is at least composed of a color generation compound, a color developing agent, and a decolorizing agent. If needed, the color material may also be selectively prepared by properly combining decolorizing temperature adjusting agent and the like so that the color of the color material may be decolorized at a temperature above a given temperature. The decolorizable toner can be prepared using a known method such as toner disclosed in the Japanese Unexamined Patent Application Publication No. 2010-191430 or the Japanese Unexamined Patent Application Publication No. 2011-113093.

As a color generation compound, a leuco dye is used as generally-known material. The leuco dye is an electron-releasing compound which can generate a color under the effect of a color developing agent which will be described later. The leuco dye is, for example, diphenylmethanephthalides, phenylindolylphthalides, indolylphthalides, diphenylmethaneazaphthalides, phenylindolylazaphthalides, fluorans, styryl quinolones, and diazarhodaminelactones, and the like.

The color developing agent constituting the color material is an electron-accepting compound which endows the leuco dye with protons. The color developing agent is, for example, phenols, metal salts of phenols, metal salts of carvone acid, aromatic carboxylic acid and aliphatic acids having 2-5 carbons, benzophenones, sulfone acid, sulphonate, phosphoric acids, metal salts of phosphoric acid, alkyl acid phosphate, metal salts of acid phosphates, phosphorous acids, metal salts of phosphorous acid, monophenols, polyphenols and 1,2,3-triazole and derivatives thereof. Further, the color developing agent may further be, for example, a material the substituent of which is alkyl group, aryl group, acyl group, alkoxycarbonyl group, carboxy group and esters thereof or amide group or halogeno group, bis-type and tris-type phenols, phenolaldehyde condensation resin, and metal salts thereof. Two or more of the compounds above may be used together.

The decolorizing agent constituting the color material can be any well-known material that can hinder the color generation reaction of a color generation compound and a color developing agent by heating in a three-component system consisting of the color generation compound, the color developing agent, and the decolorizing agent to make the system colorless. The decolorizing agent employing temperature hysteresis, which is used as a generated decolorizing mechanism, is outstanding in instant decolorizing property. In a generated decolorizing mechanism using temperature hysteresis, decolorizable toner the color of which is developed can be decolorized after being heated to a temperature above a given decolorizing temperature. For example, the decolorizable toner can be fixed on a sheet at a relatively low temperature and be decolorized at a temperature which is, for example, 10 degrees centigrade higher than the fixing temperature.

The decolorizing agent capable of causing temperature hysteresis may be, for example, alcohols, esters, ketones, ethers, and acid amides. Esters are preferable. Specifically, the decolorizing agent is, for example, carboxylic esters containing replaceable aromatic rings, carboxylic acids containing irreplaceable aromatic rings and esters of aliphatic alcohols, carboxylic esters molecularly containing cyclohexyl group, fatty acids and irreplaceable aromatic alcohols or esters of phenols, esters of fatty acids and branched aliphatic alcohols, dicarboxylic and esters of aromatic alcohols or branched aliphatic alcohols, cinnamate dibenzyl, stearin acid heptyl, didecyl adipate, adipic acid dilauryl, adipic acid dimyristyl, adipic acid dicetyl, adipic acid distearyl, trilaurin, trimyristin, tristearin, dimyristin, distearin, and the like. Two or more of the compounds above may be used together.

The binder resin may be any kind of resin that has a low melting point or a low glass transition point temperature Tg so that the resin can be fixed at a temperature lower than the decolorizing temperature of the matched color material. The binder resin may be, for example, polyester resin, polystyrene resin, styrene-acrylate copolymer resin, polyester-styrene/acrylate hybrid resin, epoxy resin, or polyether polyol resin. The binder resins may be properly selected corresponding to the matched color material.

The printer section 11 has a fixing apparatus 31 which is located between the photoconductive drum 14 and the paper discharge section 22 along a paper conveying direction. The MFP 10 has a conveyance path 27 formed along a conveyance section which conveys a sheet P from the paper feed section 13 to the paper discharge section 22 via the photoconductive drum 14 and the fixing apparatus 31. Along the conveyance path 27, the conveyance section includes a conveyance roller 28, a register roller 30, which conveys a sheet P between the photoconductive drum 14 and the transfer device 20 in synchronization with developing of the toner image on the photoconductive drum 14, and a paper discharge roller 32, which discharges the fixed sheet P to the paper discharge section 22.

With the configuration of the MFP 10 described above, the decolorizable toner image formed by the printer section 11 is transferred to a sheet P fed by the paper feed section 13. The fixing apparatus 31 fixes the decolorizable toner image onto the sheet P and the fixed sheet P is discharged to the paper discharge section 22. The image forming apparatus is not limited to this. The image forming apparatus may use non-decolorizable toner as well. The image forming apparatus may also comprise a plurality of printing sections including printing sections using decolorizable and printing sections using non-decolorizable toner. The image forming apparatus may also comprise an inkjet type printing section, which may use decolorizable ink.

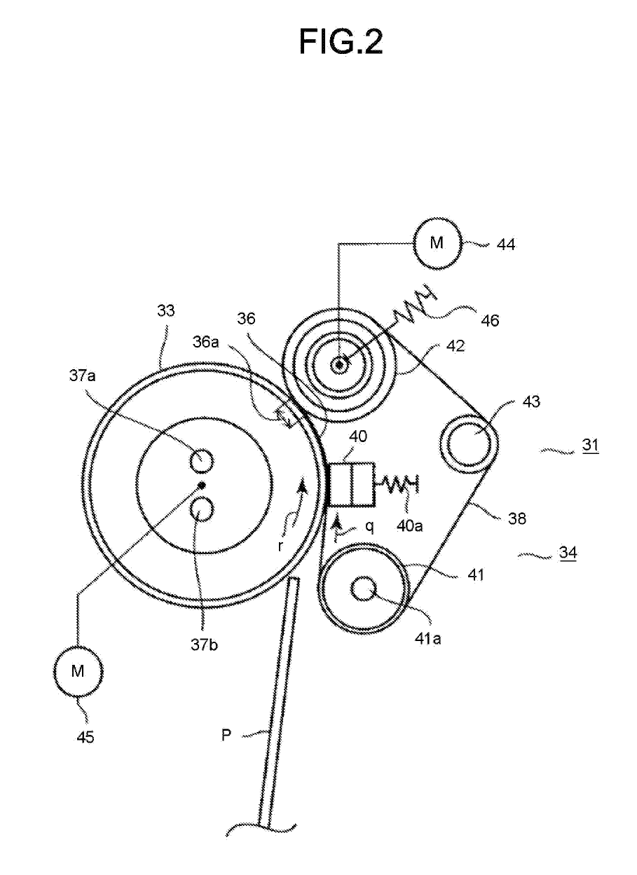

Next, the fixing apparatus 31 is described below in detail. As shown in FIG. 2, the fixing apparatus 31 comprises a heating roller 33 and a press belt mechanism 34. In the fixing apparatus 31, a nip 36 is formed between the heating roller 33 and the press belt mechanism 34, a sheet P is clamped and conveyed through the nip 36 to heat, press, and fix a toner image on the sheet P.

The heating roller 33 includes a hollow aluminum (Al) roller having a first diameter, for example, 45 mm, and a wall thickness of 1.0 mm, with a fluorine coating layer on the surface thereof. In the hollow inside of the heating roller 33, there are two halogen lamps 37a and 37b which serve as heat-generating sections generating the same quantity of heat. For example, the light distribution area of one of the two halogen lamps 37a and 37b is set to be the center area of the heating roller 33 in an axial direction, and the light distribution area of the other one of the halogen lamps 37a and 37b is set to be side areas at two sides of the center area of the heating roller 33. With the two halogen lamps 37a and 37b, the heating roller 33 generates heat in the whole axial area. The heat-generating section may also be an IH heater, but is not limited a heater lamp.

The press belt mechanism 34 comprises a press belt 38, which includes a base material such as a polyimide (PI) or nickel (Ni), a rubber layer formed there on, and a fluorine tube laminated on the rubber layer. The press belt mechanism 34 comprises a nip pad 40, having a width of, for example, 8.4 mm, which presses the press belt 38 is urged towards the heating roller 33.

The nip pad 40 is formed of, for example, adhering silicon rubber having a wall thickness of 3.5 mm on an auxiliary metal plate. The surface of the nip pad 40 that is in contact with the press belt 38 is covered with a slipping sheet so as to reduce the friction with the press belt 38. The press belt mechanism 34 has a press mechanism 40a which urges, with a second pressing force, such as a pressing force of, for example, 20N, the nip pad 40 towards the heating roller 33.

The press belt mechanism 34 has a belt heating roller 41 at a position upstream with respect to the nip pad 40 along a rotational direction of the press belt 38, that is, a direction indicated by an arrow q. The press belt mechanism 34 further has an outlet pressing roller 42 at a position downstream with respect to the nip pad 40 in the rotational direction of the press belt 38. The press belt mechanism 34 has a tension roller 43 which stretches the press belt with a certain tension and adjusts the distance between the belt heating roller 41 and the outlet pressing roller 42.

The belt heating roller 41 is formed of a hollow aluminum (Al) roller, for example, having a diameter of 17 mm and a wall thickness of 1.0 mm and a release layer formed on the surface of the roller. A halogen lamp 41a is arranged in the hollow inside of the belt heating roller 41. The tension roller 43 is formed of, for example, a stainless steel (SUS) having a diameter of 10 mm and a tube formed thereon, which is made from PFA resin (copolymer of tetrafluoroethylene and perfluo alkyl vinyl ether) having a wall thickness of 50 μm.

The belt heating roller 41 is set to be heated to a temperature that is lower than the temperature set for the heating roller 33 by 20-30° centigrade. In one embodiment, the belt heating roller 41 is set to be heated to 80° centigrade and the heating roller 33 is set to be heated to 90° centigrade. The press belt 38 is heated by the belt heating roller 41 before the sheet P is supplied on the press belt, and the back surface of the sheet P supplied on the press belt 38 is heated by the press belt 38.

By heating not only the front surface of the sheet P with the heating roller 33 but also the back surface of the sheet with the belt heating roller 41, it is possible to supply the sheet P with sufficient heat to fix the toner thereon. Further, it is possible to reduce the temperature difference between the upper surface of the toner layer and bottom surface of the toner layer supported on the sheet P. Therefore, it is not necessary to keep the heating roller 33 at a high temperature during the fixing process. Accordingly, fixing at a low enough temperature that does not cause decolorizing of the toner is possible.

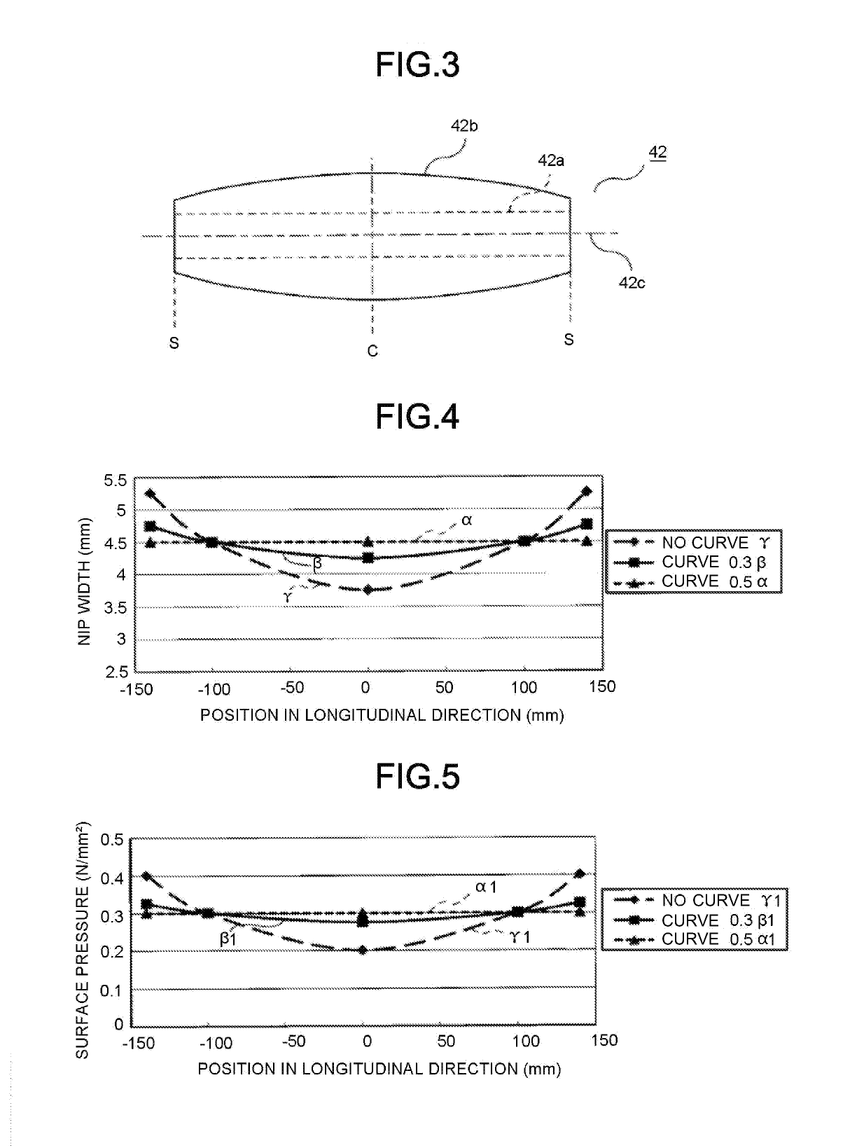

As shown in FIG. 3, the outlet pressing roller 42 has a stainless steel (SUS) core 42a having a diameter of, for example, 16 mm. The outlet pressing roller also has a solid rubber layer 42b, which has a wall thickness of 2.5 mm and a hardness of JIS-A60°, around the core 42a. The outlet pressing roller 42 is formed in a curved shape, that is, the diameter of the outlet pressing roller 42 in a direction of an axis 42c is increased from end parts to the center part. The solid rubber layer 42b is formed in such a manner that the wall thickness of the solid rubber layer 42b is increased from end parts to the center part. A curve amount, which is a difference of the diameter at the center (C) part and the diameter at the end part (S), of the outlet pressing roller 42 is 0.5 mm. The diameter of the center (C) part of the outlet pressing roller 42 having a second diameter is 21 mm, and the diameter of the end parts (S) of the outlet pressing roller 42 is 20.5 mm.

The press belt mechanism 34 stretches the press belt 38 with the belt heating roller 41, the outlet pressing roller 42, and the tension roller 43. In the fixing apparatus 31, as the press belt 38 contacts the heating roller 33 at a region extending from a region urged by the nip pad 40 of the press belt mechanism 34 to a region urged by the outlet pressing roller 42, a long nip 36 is formed. The press belt mechanism 34 has a press mechanism 46 which urges, with a first pressing force, such as a pressing force of 300N, the outlet pressing roller 42 towards the heating roller 33. Under the pressing force of the press mechanism 46, a high-pressure nip 36a is formed between the heating roller 33 and a region of the press belt 38 pressed by the outlet pressing roller 42.

In the fixing apparatus 31, a motor 44 drives the outlet pressing roller 42 to rotate, and thereby the press belt 38 moves along the direction indicated by an arrow q. In addition a motor 45 drives the heating roller 33 to rotate along the direction indicated by an arrow r. Alternatively, one of the heating roller 33 and the press belt 38 may be driven such that the other one follows the move.

Upon the starting of a printing job, in the fixing apparatus 31, the halogen lamps 37a and 37b heat the heating roller 33 to a temperature at which a fixation operation can be carried out, and the halogen lamp 41a heats the belt heating roller 41 to a given temperature. The printer section 1 of the MFP 10 forms a toner image on a sheet P, and the conveyance section conveys the sheet P to the fixing apparatus 31. The fixing apparatus 31 clamps and conveys the sheet P, on which the toner image is formed, through the nip 36 formed with the heating roller 33 rotating along the direction indicated by the arrow r and the press belt 38 rotating along the direction indicated by the arrow q. At the position of the nip pad 40, the fixing apparatus 31 heats the sheet P while gently clamping the sheet P with the heating roller 33 and the press belt 38. The fixing apparatus 31 presses the sheet P with a high pressing force at the position of the outlet pressing roller 42 to heat and press the toner image to fix the toner image on the sheet P. The conveyance section of the MFP 10 discharges the sheet P on which the toner image is heated, pressed and fixed from the paper discharge roller 32 to the paper discharge section 22.

The heat capacity of the fixing apparatus 31 is reduced for saving energy, and the wall thickness of the heating roller 33 is reduced for shortening warming-up time. When the wall thickness of the heating roller 33 is reduced, the heating roller 33 may deform during a fixation process due to the high pressure generated by the outlet pressing roller 42, which may cause the center part of the heating roller 33 to sink. The concave in the center part of the heating roller 33 fits the outlet pressing roller 42 having a curved shape with a curve amount of 0.5 mm. Despite of the concave in the center part of the heating roller 33, the width of and the pressing force at the nip 36a formed with the outlet pressing roller 42 are substantially equal in the whole longitudinal direction of the heating roller 33.

The distribution of the nip width of the nip 36a between the heating roller 33 at the position of the outlet pressing roller 42 and the press belt 38 is measured. If an outlet pressing roller 42 having a curve amount of 0.5 mm is used, the nip width, which is substantially equal in the whole longitudinal direction of the heating roller 33, is about 4.5 mm, as shown by the dotted line a shown in FIG. 4. As a comparative example, a straight tube roller without a curve is used instead of the outlet pressing roller 42. According to the comparative example, the nip width in the longitudinal direction of the heating roller 33 varies significantly from about 3.7 mm at the center part of the heating roller to about 5.3 mm at end parts of the heating roller, as shown by the chain line γ.

As an alternative example, an outlet pressing roller 42 having a curve amount of 0.3 mm is used. The nip width in the longitudinal direction of the heating roller 33 varies from about 4.2 mm at the center part of the heating roller to about 4.7 mm at end parts of the heating roller, as shown by the solid line β. In the use of the roller having a smaller curve amount described in the alternative example, the nip width, although not uniform in the longitudinal direction of the heating roller 33, is improved in variation amount when compared with that obtained with the straight tube roller described in the comparative example.

The surface pressure distribution in the longitudinal direction of the nip 36a formed between the heating roller 33 at the position of the outlet pressing roller 42 and the press belt 38 is shown by the dotted line α1 as shown in FIG. 5. If an outlet pressing roller 42 having a curve amount of 0.5 mm is used, the surface pressure of the nip 36a, which is substantially uniform in the whole longitudinal direction of the heating roller 33, is about 0.3 (N/mm²). If the straight tube roller without a curve described in the comparative example is used, as shown by the chain line γ1, the surface pressure of the nip 36a in the longitudinal direction of the heating roller 33 varies significantly from about 0.2 (N/mm²) at the center part of the heating roller 33 to about 0.4 (N/mm²) at end parts of the heating roller 33.

If the roller having a curve amount of 0.3 mm described in the alternative example is used, as shown by the solid line 131, the surface pressure of the nip 36a in the longitudinal direction of the heating roller 33 varies from about 0.28 (N/mm²) at the center part of the heating roller 33 to about 0.32 (N/mm²) at end parts of the heating roller 33. In the alternative example in which the curve amount is smaller, the surface pressure of the nip 36a, although not uniform in the longitudinal direction of the heating roller 33, is improved in variation amount when compared with that obtained with the straight tube roller described in the comparative example.

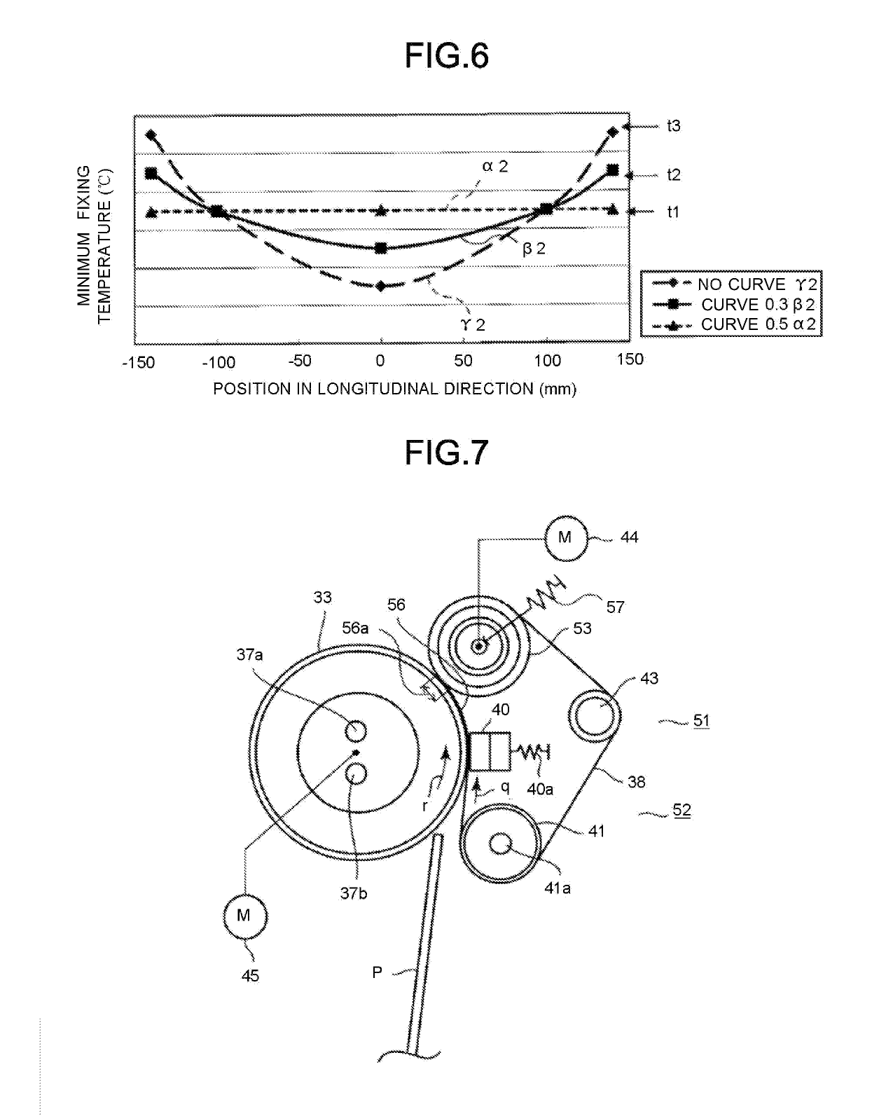

In order to achieve an excellent fixation property, temperature of the heating roller 33 is set to a predetermined temperature in the whole longitudinal direction thereof corresponding to a temperature of an area in which a minimum fixing temperature (a minimum temperature required to fix toner onto a sheet) is the highest. The variation of the minimum fixing temperature in the longitudinal direction of the heating roller is measured with respect to each of the outlet pressing rollers having a different shape. If an outlet pressing roller 42 having a curve amount of 0.5 mm is used, the minimum fixing temperature is substantially equal to a temperature t1 in the whole longitudinal direction of the heating roller 33, as shown by the dotted line α2 as shown in FIG. 6. If the roller without a curve described in the comparative example is used, the minimum fixing temperature becomes higher from the center part to the end parts of the heating roller 33, as shown by the chain line γ2. In the comparative example, at the end parts of the heating roller 33, the minimum fixing temperature is a temperature t3, which is much higher than the temperature t1.

If the roller having a curve amount of 0.3 mm described in the alternative example is used, the lower limit fixing temperature becomes higher from the center part to the end parts of the heating roller 33, as shown by solid line β2. In the alternative example, at the end parts of the heating roller 33, the minimum fixing temperature is a temperature t2. In the alternative example in which the curve amount is 0.3 mm, the minimum fixing temperature, although higher than that obtained in the use of an outlet pressing roller 42 having a curve amount of 0.0.5 mm, is lower than the temperature t3 obtained in the comparative example. If the outlet pressing roller 42 having a curve amount of 0.5 mm is used, the highest value of the minimum fixing temperature of the heating roller 33 can be lowered, and therefore energy consumed during a fixation process can be saved.

According to the first embodiment, the outlet pressing roller 42 for pressing the heating roller 33 through the press belt 38 is formed in a curved shape having a curve amount of 0.5 mm, and the pressing force of the outlet pressing roller 42 is set to be 300N. Even if the heating roller 33 is deformed, the width and the surface pressure of the nip 36a at the position of the outlet pressing roller 42 are substantially uniform in the whole longitudinal direction of the heating roller 33. Thus, according to the first embodiment, a substantially uniform heating, pressing, and fixing property is obtained in the whole longitudinal direction of the heating roller 33.

According to the first embodiment, a substantially uniform surface pressure can be obtained in a longitudinal direction at the position of the nip 36a even if a heating roller 33 which deforms easily due to the thin wall thereof is used. The wall of the heating roller 33 can be thinned to save energy or shorten the warming-up time of the fixing apparatus 31. In accordance with the first embodiment, the width of the nip 36a at the position of the outlet pressing roller 42 can be substantially uniform in a longitudinal direction. Thus, the highest value of the minimum fixing temperature of the heating roller 33 can be lowered. As the highest value of the minimum fixing temperature of the heating roller 33 can be lowered, the predetermined temperature of the heating roller 33 can be lowered and energy consumed during a fixation process can be saved. As the predetermined temperature of the heating roller 33 can be lowered, there is little risk of erasing a toner image even if the MFP 10 uses decolorizable toner. Consequentially, the toner image can be reliably heated, pressed, and fixed on a sheet P.

Further, it is preferable to provide the belt heating roller 41, the outlet pressing roller 42, and the tension roller 43 with an insulating material on their respective metal cores. As the insulating material, rubber and resin can be used. It is desirable to keep the press belt 38 at a predetermined heated condition during the fixing. When this is not satisfied, the temperature of the heating roller 33 needs to be raised to supplement the heat for fixing the toner. This might, however, cause the decolorizing of the toner. By using the insulating material for the belt heating roller 41, the outlet pressing roller 42, and tension roller 43, which respectively contact the heat press belt 38, leaking of the heat is prevented.

In view of its insulating property, the foaming rubber is available as the insulating material. However, the outlet pressing roller 42 is pressed against the heating roller 33 with high pressure. To withstand this high pressure, solid rubber material is used for the outlet pressing roller 42.

### Second Embodiment

An image forming apparatus according to a second embodiment is described below with reference to FIG. 7 to FIG. 11. The second embodiment is an embodiment in which the outlet pressing roller of the fixing apparatus described in the first embodiment is replaced with another outlet pressing roller having a different structure, and the pressing force applied to the heating roller by the outlet pressing roller is also changed. The elements of the image forming apparatus according to the second embodiment which is the same as those described in the first embodiment are denoted by the same reference symbol and are therefore not described here in detail.

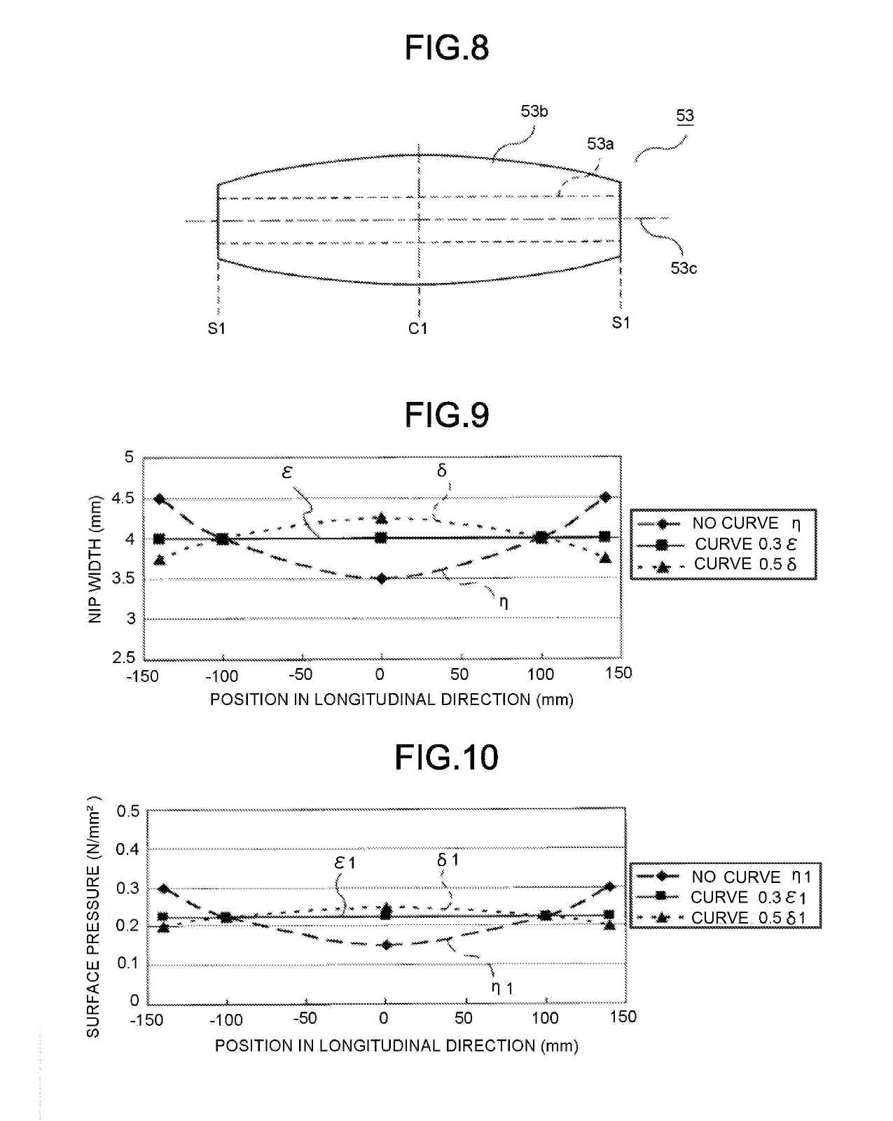

As shown in FIG. 7, according to the second embodiment, a press belt mechanism 52 of a fixing apparatus 51 has an outlet pressing roller 53 at a position downstream with respect to the nip pad 40 in a rotational direction of the press belt 38, that is, a direction indicated by a arrow q. As shown in FIG. 8, the outlet pressing roller 53 comprises a stainless steel (SUS) core 53a having a diameter of, for example, 17 mm. The outlet pressing roller 53 also has a solid rubber layer 53b having a wall thickness of 2 mm and a hardness of JIS-A60° around the core 53a. The outlet pressing roller 53 is formed in a curved shape in a direction of an axis 53c. That is, the diameter of the outlet pressing roller 53 is increased from end parts to the center part. The solid rubber layer 53b is formed in such a manner that the wall thickness of the solid rubber layer 53b is increased from end parts to the center part. The curve amount of the outlet pressing roller 53 is 0.3 mm. The diameter of a center (C1) part of the outlet pressing roller 53 having a second diameter is 21 mm, and the diameter of end parts (S1) of the outlet pressing roller 53 is 20.7 mm.

In the fixing apparatus 51, as the press belt 38 contacts the heating roller 33 at a regions extending from a region urged by the nip pad 40 of the press belt mechanism 52 to a region urged by the outlet pressing roller 53, a long nip 56 is formed. The press belt mechanism 52 has a press mechanism 57 which urges, with a first pressing force such as a pressing force of 230N, the outlet pressing roller 53 towards the heating roller 33. Under the pressing force of the press mechanism 57, a high-pressure nip 56a is formed between the heating roller 33 and a region of the press belt 38 pressed by the outlet pressing roller 53.

The fixing apparatus 51 heats a sheet P on which a toner image is formed by the printer section 11 while gently clamping the sheet P with the heating roller 33 and the press belt 38 at the position of the nip pad 40. The fixing apparatus 51 presses the sheet P with a high pressing force at the position of the outlet pressing roller 53 to heat and press the toner image to fix the toner image on the sheet P.

Under the pressure of the outlet pressing roller 53, the heating roller 33 having a thin wall may deform during the fixation process, which may cause the center part of the heating roller to sink. The concave in the center part of the heating roller 33 fits the outlet pressing roller 53 having a curved shape with a curve amount of 0.3 mm. Despite of the concave in the center part of the heating roller 33, the width of and the pressing force at the high-pressure nip 56a formed with the outlet pressing roller 53 are substantially uniform in the whole longitudinal direction of the heating roller 33.

The distribution of the nip width of the nip 56a between the heating roller 33 at the position of the outlet pressing roller 53 and the press belt 38 is shown by the solid line ε as shown in FIG. 9. If an outlet pressing roller 53 having a curve amount of 0.3 mm is used, the nip width in the longitudinal direction of the nip 56a, which is substantially uniform in the whole longitudinal direction of the heating roller 33, is about 4 mm. As a comparative example, a straight tube roller without a curve is used instead of an outlet pressing roller. According to the comparative example, the nip width in the longitudinal direction of the heating roller 33 varies significantly from about 3.5 mm at the center part of the heating roller to about 4.5 mm at end parts of the heating roller, as shown by the chain line η.

As an alternative example, an outlet pressing roller 53 having a curve amount of 0.5 mm is used. The nip width in the longitudinal direction of the heating roller 33 varies from about 4.2 mm at the center part of the heating roller to about 3.7 mm at end parts of the heating roller, as shown by the dotted line δ. In the alternative example in which the curve amount is greater, in the longitudinal direction of the heating roller 33, the nip width at the center part of the heating roller is greater than that at the end parts of the heating roller. However, the nip width according to the alternative example in which the curve amount is greater is improved in variation amount when compared with the variation amount obtained with the straight tube roller described in the comparative example.

The surface pressure distribution in the longitudinal direction of the nip 56a formed between the heating roller 33 at the position of the outlet pressing roller 53 and the press belt 38 is shown by the solid line ε1 as shown in FIG. 10. If an outlet pressing roller 53 having a curve amount of 0.3 mm is used, the surface pressure of the nip 56a, which is substantially uniform in the whole longitudinal direction of the heating roller 33, is about 0.22 (N/mm²). If the straight tube roller without a curve described in the comparative example is used, as shown by the chain line η1, the surface pressure of the nip 56a in the longitudinal direction of the heating roller 33 varies significantly from about 0.15 (N/mm²) at the center part of the heating roller to about 0.3 (N/mm²) at end parts of the heating roller 33.

If the roller having a curve amount of 0.5 mm described in the alternative example is used, as shown by the dotted line δ1, the surface pressure of the nip 56a in the longitudinal direction of the heating roller 33 varies from about 0.24 (N/mm²) at the center part of the heating roller to about 0.2 (N/mm²) at end parts of the heating roller. In the alternative example in which the curve amount is greater, in the longitudinal direction of the heating roller 33, the surface pressure at the center part of the heating roller is greater than that at end parts of the heating roller. However, the surface pressure according to the alternative example in which the curve amount is great is improved in variation amount when compared with that obtained in the use of the straight tube roller described in the comparative example.

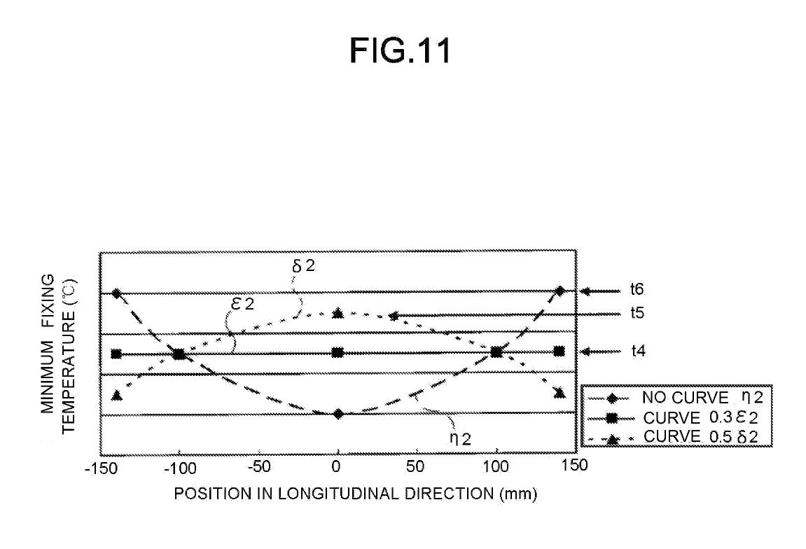

The variation of the minimum fixing temperature in the longitudinal direction of the heating roller is measured with respect to each of the outlet pressing rollers having a different shape. If an outlet pressing roller 53 having a curve amount of 0.3 mm is used, the minimum fixing temperature, which is substantially uniform in the whole longitudinal direction of the heating roller 33, is a temperature t4, as shown by the solid line ε2 as shown in FIG. 11. If the outlet pressing roller without a curve described in the comparative example is used, the minimum fixing temperature becomes higher from the center part to the end parts of the heating roller 33, as shown by the chain line η2. In the comparative example, at the end parts of the heating roller 33, the minimum fixing temperature is a temperature t6, which is much higher than the temperature t4.

If the roller having a curve amount of 0.5 mm described in the alternative example is used, the lower limit fixing temperature, which is lower at end parts, becomes higher from end parts to the center part. In the alternative example, the minimum fixing temperature at the center part of the heating roller 33 is a temperature t5, as shown by the dotted line δ2. In the alternative example in which the curve amount is greater, the minimum fixing temperature, although higher than that obtained with the outlet pressing roller 53 having a curve amount of 0.3 mm, is lower than the temperature t6 in the comparative example and is therefore improved. If the outlet pressing roller 53 having a curve amount of 0.3 mm is used, the minimum fixing temperature of the heating roller 33 can be lowered, and therefore energy consumed during a fixation process can be saved.

According to the second embodiment, the outlet pressing roller 53 for pressing the heating roller 33 through the press belt 38 is formed in a curved shape having a curve amount of 0.3 mm, and the pressing force of the outlet pressing roller 53 is set to be 230N. Even if the heating roller 33 is deformed, like in the first embodiment, the width and the surface pressure of the nip 56a at the position of the outlet pressing roller 53 are substantially uniform in the whole longitudinal direction. Therefore, a substantially uniform fixation property is obtained in the whole longitudinal direction.

According to the second embodiment, the wall thickness of the heating roller 33 can be reduced to save energy or shorten the warming-up time of the fixing apparatus 51. According to the second embodiment, as the highest value of the minimum fixing temperature of the heating roller 33 can be lowered, the predetermined temperature of the heating roller 33 can be lowered, and energy consumed during a fixation process can be saved. As the predetermined temperature of the heating roller 33 can be lowered, there is little risk of erasing a toner image even if the MFP 10 uses decolorizable toner. Consequentially, the toner image can be reliably heated, pressed, and fixed on a sheet P.

As stated in the embodiments above, the outlet pressing roller is formed in a curved shape. However, the heating roller may also be formed in a curved shape. Moreover, both the outlet pressing roller and the heating roller may be formed in a curved shape. However, in a case where the heating roller is formed in a curved shape, the heat capacity of the heating roller may be less uniform due to the less uneven thickness of the heating roller in the longitudinal direction. In a case where the heating roller is formed in a curved shape, it is harder to increase the curve amount of the heating roller. By the outlet pressing roller, instead of the heating roller, being formed in a curved shape, the heat capacity of the heating roller in the longitudinal direction can be more reliably unified and the heating roller can be heated more uniformly. By the outlet pressing roller being formed in a curved shape, the surface pressure of the nip in the whole longitudinal direction of the heating roller can be more reliably unified without impairing the uniformity of heat generation.

Further, no limitation is given to the material or shape of the core of the outlet pressing roller, and no limitation is given to the thickness or rubber hardness of the solid rubber layer. The curve amount may be changed within a range from 0.1 mm to 0.6 mm according to the size, material, or pressing force of the outlet pressing roller. However, the deformation of the heating roller occurring during a fixation process cannot be coped with if the curve amount is small. On the other hand, if the curve amount is too large, the curved shape may be too tight compared to the deformed shape of the heating roller. Preferably, the curve amount is 0.3-0.6 mm.

According to at least one of the embodiments above, at least one of the heating roller and the pressing roller is formed in a curved shape. During a fixation process, even if the heating roller is deformed under the pressure of the pressing roller, the surface pressure of the nip at the position of the pressing roller can be substantially unified in the whole longitudinal direction, and a uniform fixation property in the longitudinal direction can be obtained. The wall thickness of the heating roller can be reduced to save energy or shorten warming-up time. By lowering the predetermined temperature of the heating roller, energy can be saved, and moreover, even for an image formed with a coloring agent such as decolorizable toner or ink, the image can be reliably heated, pressed, and fixed without being decolorized.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A fixing apparatus, comprising:
a first rotating unit having a heat generating unit and center and end portions that are configured to rotate around a first rotational axis; and
a second rotating unit having center and end portions that are configured to rotate around a second rotational axis, the second rotating unit being urged towards the first rotating unit and positioned to form a nip between the first rotating unit and the second rotating unit,
at least one of the first rotating unit and the second rotating unit having a shape where a diameter of the center portion is greater than a diameter of the end portion.

2. The fixing apparatus according to claim 1, wherein a difference between the diameter at the center portion and the diameter at the end portion is equal to or greater than 0.1 mm and equal to or smaller than 0.6 mm.

3. The fixing apparatus according to claim 1, wherein the second rotating unit has the shape, and the other one of the first rotating unit and the second rotating unit has a uniform shape along the direction of the rotational axis.

4. The fixing apparatus according to claim 3, wherein the second rotating unit includes:
a core roller, and
an elastic layer formed on an outer periphery of the core roller, the elastic layer having the shape.

5. The fixing apparatus according to claim 1, wherein a diameter of the second rotating unit continuously decreases from the center portion towards the end portion along the direction of the rotational axis.

6. The fixing apparatus according to claim 5, wherein a length of the nip in a sheet conveying direction at the center portion is the same as a length of the nip in the sheet conveying direction at the end portion.

7. The fixing apparatus according to claim 5, wherein a pressing force at the center portion is the same as a pressing force at the end portion.

8. The fixing apparatus according to claim 5, wherein a temperature of the first rotating unit required to fix the toner image at the center portion is the same as the temperature of the first rotating unit required to fix the toner image at the end portion.

9. An image forming apparatus, comprising:
an image forming unit configured to form a toner image; and
a fixing unit configured to fix the formed toner image onto a sheet and including:
a first rotating unit having a heat generating unit and center and end portions that are configured to rotate around a first rotational axis, and
a second rotating unit having center and end portions that are configured to rotate around a second rotational axis, the second rotating unit being urged towards the first rotating unit and positioned to form a nip between the first rotating unit and the second rotating unit,
at least one of the first rotating unit and the second rotating unit having a shape where a diameter of the center portion is greater than a diameter of the end portion.

10. The image forming apparatus according to claim 9, wherein a difference between the diameter at the center portion and the diameter at the end portion is equal to or greater than 0.1 mm and equal to or smaller than 0.6 mm.

11. The image forming apparatus according to claim 9, wherein the second rotating unit has the shape, and the other one of the first rotating unit and the second rotating unit has a uniform shape along the direction of the rotational axis.

12. The image forming apparatus according to claim 11, wherein the second rotating unit includes:
a core roller, and
an elastic layer formed on an outer periphery of the core roller, the elastic layer having the shape.

13. The image forming apparatus according to claim 9, wherein a diameter of the second rotating unit continuously decreases from the center portion towards the end portion along the direction of the rotational axis.

14. The image forming apparatus according to claim 13, wherein a length of the nip in a sheet conveying direction at the center portion is the same as a length of the nip in the sheet conveying direction at the end portion.

15. The image forming apparatus according to claim 13, wherein a pressing force at the center portion is the same as a pressing force at the end portion.

16. The image forming apparatus according to claim 13, wherein a temperature of the first rotating unit required to fix the toner image at the center portion is the same as the temperature of the first rotating unit required to fix the toner image at the end portion.

17. A fixing apparatus, comprising:
a first rotating unit having a heat generating unit and center and end portions that are configured to rotate around a first rotational axis; and
a second rotating unit having center and end portions that are configured to rotate around a second rotational axis, the second rotating unit being urged towards the first rotating unit and positioned to form a nip between the first rotating unit and the second rotating unit,
wherein a length of the nip in a sheet conveying direction at the center portion is the same as a length of the nip in the sheet conveying direction at the end portion.

18. The fixing apparatus according to claim 17, wherein a pressing force at the center portion is the same as a pressing force at the end portion.

19. The fixing apparatus according to claim 17, wherein a temperature of the first rotating unit required to fix the toner image at the first portion is the same as a temperature of the first rotating unit required to fix the toner image at the second portion.

20. The fixing apparatus according to claim 19, further comprising:
a control unit configured to control the heat generating unit, such that a temperature of the first rotating unit at both the center and end portions becomes a predetermined temperature that is required to fix the toner image.
